(19) United States
(12) Patent Application Publication
(10) Pub. No.: US 2005/0197603 A1
(43) Pub. Date: Sep. 8, 2005

(54) Multi-section exercise and massage track

(76) Inventor: Moon Hyo Kim, Los Angeles, CA (US)

Correspondence Address: Jerry H. Noh, Suite 2741, 3435 Wilshire Blvd, Los Angeles, CA, 90010, US

(21) Appl. No.: 10/793,259

(22) Filed: Mar. 4, 2004

(51) Int. Cl. A61H 7/00

(52) U.S. Cl. 601/134; 601/136; 601/138

(57) ABSTRACT

A track comprising seven connected sections forming a loop and an entry section leading into the first of the seven sections. The first section connects to the second section, which connects to the third section, which connects to the fourth section, which connects back to the first section. The fifth, sixth, and seventh sections all are placed between the third and first sections. The third and fifth sections are filled with an identical material of a predetermined size, and each of the first, second, fourth, sixth, and seventh sections are filled with a corresponding material of different size than the material contained in the other sections. In use of this track, a beginning person first walks through the entry path and onto the first section. Then the person walks through the first, second, third, and fourth sections repeatedly for a predetermined period of time depending on the length of the track. With progress, the person then walks laps substituting the fourth section instead with the fifth section. With additional progress, the person walks laps substituting the fifth section with the sixth section. And finally, with final progress, the person walks laps substituting the sixth section with the seventh section.

### BACKGROUND OF THE INVENTION

I. Field of the Invention

This invention pertains generally to a track. More specifically, the invention concerns a multi-section exercise track which promotes one's health through massaging targeted points on the user's feet.

II. Description of the Prior Art

Acupressure is a form of massage in which specific points on the body are targeted for application of pressure thereon. Each specific acupressure point is associated with parts of the body including the various organs and nervous system. The feet in particular is known to have numerous acupressure points which extend to nearly every important part of the body including all of the major organs and nervous system. It is important to apply the right amount of pressure with proper balance on the acupressure points of the feet for effective acupressure therapy. Furthermore, it is known for proper therapy to apply different amounts and types of pressure at varying points of the feet during different stages of a therapy program for a person and for different conditions of differing persons.

Cardiovascular exercise in which the heart rate of the person is raised through a specific activity such as walking or jogging also is known to improve a person's health. The raising of the heart rate also increases the breathing rate and provides more oxygen to the body which has been known in modem medicine to increase vitality of the heart and lungs as well as strengthen the arteries while increasing the rate at which waste material are broken down.

It is desirable to combine the benefits of acupressure massage and cardiovascular exercise. One such device known in the prior art is slippers having a foot contact surface comprised of a plurality of protruding studs. The wearer of the slipper walks around and receives application of pressure on the bottom surface of each foot with each step taken. A disadvantage of this type of slipper is that the same amount of pressure and nearly the same points on each foot is applied with almost every step. As such there is no adjustable variety for different persons and for different stages of usage for a person.

None of the prior art teaches a track and method of exercise and feet massage as taught in the present invention.

Thus, it is a primary objective of the present invention to provide a track which is ideal for cardiovascular exercise and varying feet massage for acupressure therapy.

### BACKGROUND AND SUMMARY OF THE INVENTION

This invention provides a track comprising several sections. One embodiment of the track has four different sections: a first section, a second section, a third section, and a fourth section forming a complete loop with the first section connecting to and leading into the second section, the second section connecting to and leading into the third section, the third section connecting to and leading into the fourth section, and the fourth second connecting to and leading back into the first section to complete the loop. Each section is filled with a material having a different size than the material in the other sections. The track has a depth sufficient to hold the corresponding material within the track. There is an entry path which connects to the first section, and the entry path is filled with a material of different type than the other sections. Natural substances which have non heat-conducting properties are preferred for each material filling each corresponding section. In use, the fourth section is replaced with materials of a greater size with progression of the user in a predetermined course of therapy.

In another embodiment, the track has seven sections and an entry section. The seven sections form a loop with the first section connecting to the second section and the second section connecting to the third section and the third section connecting to the fourth section and the fourth section connecting back to the first section. The entry path connects to the first section. The fifth, sixth, and seventh sections all are placed between the third and first sections. The third and fifth sections are filled with an identical material of a predetermined size, and each of the first, second, fourth, sixth, and seventh sections are filled with a corresponding material of different size than the material contained in the other sections. In use of this embodiment, a beginning person first walks through the entry path and onto the first section. Then the person walks through the first, second, third, and fourth sections repeatedly for a predetermined period of time depending on the length of the track. With progress, the person then walks through the first, second, third, and fifth sections repeatedly for a predetermined period of time depending on the length of the track. Thereafter with sufficient progress with this cycle, the person walks through the first, second, third, and sixth sections repeatedly for a predetermined period of time depending on the length of the track. Finally, as the final step in the progression, the person walks through the first, second, third, and seventh sections repeatedly for a predetermined period of time depending on the length of the track. The entry path is also walked on when exiting the track. Each material filling the corresponding sections should preferably be of a natural material and should be of a non heat-conducting material such as sand, stones, and rocks.

### BRIEF DESCRIPTION OF THE DRAWING

With the above and additional objects and advantages in view, as will hereinafter appear, this invention comprises the devices, combinations and arrangements of parts hereinafter described, by way of example, and illustrated in the accompanying drawings of a preferred embodiment in which:

FIG. 1 is a top plan view of an embodiment of the present invention;

FIG. 2 is a view of a cross-section of the present invention cut along the A-A line of FIG. 1;

FIG. 3 is a top plan view of another embodiment of the present invention; and,

FIG. 4 is a top plan view of yet another embodiment of the present invention.

### DESCRIPTION OF THE PREFERRED EMBODIMENT

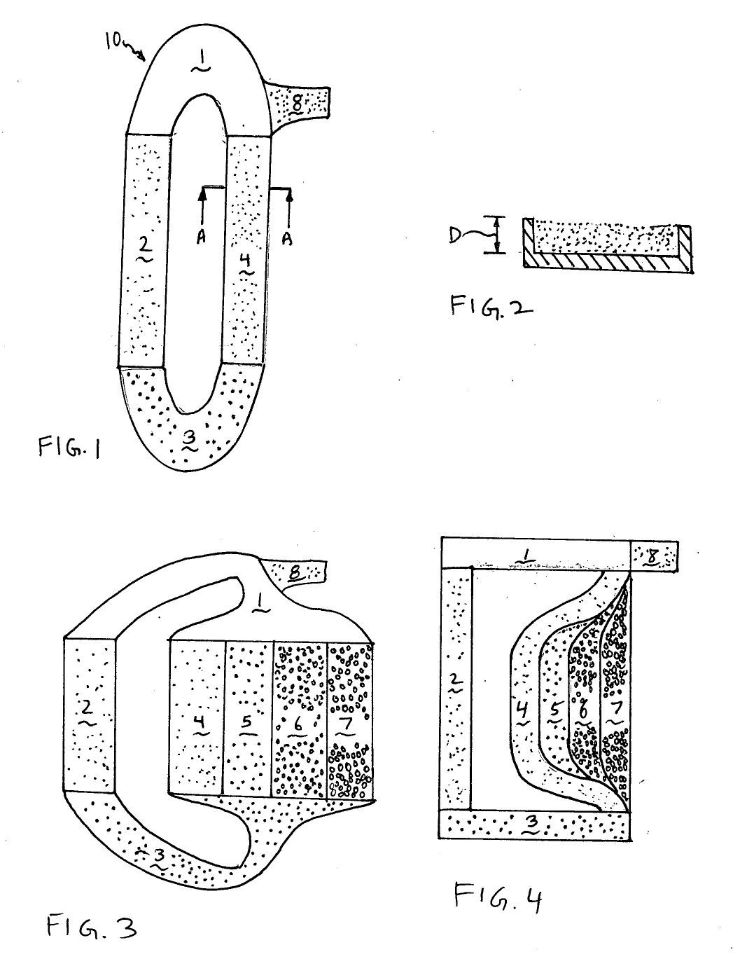

The present invention is illustrated in FIGS. 1 to 4. The embodiment shown in FIG. 1 has a track 10 comprising of four different sections: a first section 1, a second section 2, a third section 3, and a fourth section 4. The track 10 forms a complete loop with the first section 1 connecting to and leading into the second section 2, the second section 2 connecting to and leading into the third section 3, the third section 3 connecting to and leading into the fourth section 4, and the fourth section 4 connecting to and leading back into the first section 1 to complete the loop. Each section 1, 2, 3, 4 is filled with a material having a different size than the material in the other sections. The materials in the different sections are not necessarily of the same type. The track 10 has a predetermined depth D as shown in the cross-sectional view of the track illustrated in FIG. 2. The depth should be sufficient to hold the corresponding material within the track. In the embodiment shown, the material in the first section 1 is soft clay, the material in the second section 2 is sand, the material in the third section 3 is small pebbles having a diameter between 5 to 10 millimeters, and the fourth section 4 is made of coarse granules of sand having a diameter between 2 to 5 millimeters. Also shown in the embodiment shown is an entry path 8 connecting and leading into the first section. The material filling the entry section 8 is a mixture of grounded granules of sodium chloride and coal. But for the soft clay, the materials filling each section are chosen because of its properties of being firm, and non-heat conducting. Natural materials such as all types of stones and rocks are preferred both because they are naturally occurring and exhibit the desired properties stated earlier. For each of the materials described in the embodiment shown, a substitute material can be used as long as the substitute material is of the same size for the corresponding section and is non-heat conducting.

In use, a beginning user would first get onto the track by walking through the entry path and onto the first section 1. The user would first walk around the track for a predetermined number of laps depending on the length of the track. Thereafter with progress, the fourth section 4 is replaced with another material which is identical to the material in the third section 3, and the user walks around the track for a predetermined number of laps. Thereafter with further progress, the fourth section 4 is replaced with another material which in the embodiment shown are stones having a diameter of substantially ¾ to 1 inch, and the user walks around the track for a predetermined number of laps. Thereafter as the final step in the progression, the fourth section 4 is again replaced with another material which in the embodiment shown are stones having a diameter of greater than 1 inch or greater, and the user walks around the track for a predetermined number of laps. The user should exit the track by walking through the entry section 8.

In other embodiments shown in FIGS. 3 and 4, the track has seven sections and an entry section 8. The seven sections forming a loop are the first section 1, second section 2, third section 3, fourth section 4, fifth section 5, sixth section 6, and seventh section 7. The first section 1 connects and leads into the second section 2, and the second section 2 connects and leads into the third section 3. The fourth 4, fifth 5, sixth 6, and seventh 7 sections all are placed between the third 3 and first 1 sections as shown in FIGS. 3 and 4. In the embodiment illustrated in FIG. 3, the third section 3 connects and can lead into each of the fourth 4, fifth 5, sixth 6, and seventh 7 sections. That is, the user can decide from the third section whether to continue onto the fourth section 4, fifth section 5, sixth section 6, or the seventh section 7. The fourth 4, fifth 5, sixth 6, and seventh 7 sections connect and lead back into the first section 1. Each section has a depth D for containing a material therein. The third 3 and fifth 5 sections are filled with an identical material of a predetermined size, which in the embodiment shown are coarse pebbles having a diameter of 5 to 10 millimeters. Each of the first 1, second 2, fourth 4, sixth 6, and seventh 7 sections are filled with a corresponding material of different size than the material contained in the other sections. In the embodiment shown in FIGS. 3 and 4, the first section 1 is filled with soft clay; the second section 2 is filled with sand; the fourth section 4 is filled with coarse sand granules having a diameter between 2 to 5 millimeters; the sixth section 6 is filled with stones having a diameter substantially between ¾ to 1 inches; and the seventh section 7 is filled with stones having a diameter 1 inch or greater. The entry path 8 also has a depth and is filled with a mixture of grounded granules of sodium chloride and coal.

In use of the embodiments shown in FIGS. 3 and 4, a beginning person first walks through the entry path and onto the first section 1. Then the person walks through the first 1, second 2, third 3, and fourth 4 sections repeatedly for a predetermined period of time depending on the length of the track. With progress, the person then walks through the first 1, second 2, third 3, and fifth 5 sections repeatedly for a predetermined period of time depending on the length of the track. Thereafter with sufficient progress with this cycle, the person walks through the first 1, second 2, third 3, and sixth 6 sections repeatedly for a predetermined period of time depending on the length of the track. Finally, as the final step in the progression, the person walks through the first 1, second 2, third 3, and seventh 7 sections repeatedly for a predetermined period of time depending on the length of the track. The entry path is also walked on when exiting the track. Each material filling the corresponding sections should preferably be of a natural material and should be of a non heat-conducting material such as sand, stones, and rocks.

While embodiments of the invention have been described and illustrated for purposes of clarity and example, it should be understood that many changes, substitutions and modifications to the described embodiment will be apparent to those having skill in the art in light of the foregoing disclosure without departing from the scope and spirit of the present invention which is defined by the claim which will follow.

1. A multi-section track comprising:
a first section, a second section, a third section, and a fourth section;
said first section leading into said second section, said second section leading into said third section, said third section leading into said fourth section, said fourth section leading back into said first section; and,
each section filled with a corresponding material of different size than the other sections.

2. A multi-section track as described in claim 1 further comprising an entry section leading into said first section; and said entry section is filled with a material of different type than each material filling said corresponding first section, second section, third section, and fourth section.

3. A multi-section track as described in claim 1 wherein said multi-section track has a predetermined depth sufficient to hold the corresponding material contained within each section therein.

4. A multi-section track comprising:
a first section, a second section, a third section, a fourth section, a fifth section, a sixth section, and a seventh section;
said first section leading into said second section, said second section leading into said third section, said third section leading into each of said fourth section, said fourth section leading back into said first section;
said fifth, sixth, and seventh sections disposed between said third section and first section;
said third and fifth sections filled with an identical material of a predetermined size; and,
each of said first, second, fourth, sixth, and seventh sections filled with a corresponding material of different size than the other sections.

5. A multi-section track as described in claim 4 further comprising an entry section leading into said first section; and said entry section is filled with a material of different type than each corresponding material filling said other sections.

6. A multi-section track as described in claim 4 wherein said multi-section track has a predetermined depth sufficient to hold the corresponding material contained within each section therein.

7. A method of exercising and massaging a person's feet on a multi-section track having a first section, a second section, a third section, a fourth section, a fifth section, a sixth section, and a seventh section, said first section leading into said second section, said second section leading into said third section, said third section leading into each of said fourth section, said fourth section leading back into said first section, said fifth, sixth, and seventh sections being disposed between said third section and first section, said third and fifth sections filled with an identical material of a predetermined size, each of said first, second, fourth, sixth, and seventh sections filled with a corresponding material of different size than the other sections, said method comprising the steps of:
walking through the first, second, third, and fourth sections repeatedly for a predetermined period of time;
walking thereafter through the first, second, third, and fifth sections repeatedly for a predetermined period of time;
walking thereafter through the first, second, third, and sixth sections repeatedly for a predetermined period of time; and,
walking thereafter through the first, second, third, and seventh sections repeatedly for a predetermined period of time.
